(19) United States
(12) Patent Application Publication
(10) Pub. No.: US 2013/0290326 A1
(43) Pub. Date: Oct. 31, 2013

(54) System for dynamically linking tags with a virtual repository of a registered user

(71) Applicant: Yevgeniy Lebedev, Basking Ridge, NJ (US)

(72) Inventor: Yevgeniy Lebedev, Basking Ridge, NJ (US)

(21) Appl. No.: 13/455,200

(22) Filed: Apr. 25, 2012

(51) Int. Cl. G06F 17/30

(52) U.S. Cl. 707/736; 707/E17.001

(57) ABSTRACT

A system and related method for dynamically linking tags with a virtual repository of a registered user are disclosed.

### TECHNICAL FIELD

The invention relates to a system and related method for dynamically linking tags with a virtual repository of a registered user.

### BACKGROUND

A tag having a bar code such as a quick response code (QR code) is a matrix barcode (or two-dimensional code) that has become popular due to its fast readability. In recent years it become widely used in consumer advertising, because it provides quick and effortless access to the brand's website. This linking of a tag such as a QR code tag to the web content is conducted by creating some content by a user, publishing the content on the web, making the content available via uniform resource locators (URLs), using an application to generate a tag using an URL as an input parameter, and finally printing the tag. The outlined above prior art method requires some level of technical knowledge on the part of a user and proximity or availability of the printer if the tag needs to be printed. The prior art systems do not provide users with convenient and efficient ways of creating and storing data as well as accessing it using virtual or printed tags. Moreover, the prior art systems do not provide for creating a user-defined access to the data created by the user and stored in the virtual space. Therefore, there is a need for a system and related method that overcome the mentioned-above deficiencies of the prior art systems and methods.

### SUMMARY

It is therefore an object of the present invention to provide a system and related method for conveniently and efficiently creating and storing data as well as accessing it using virtual or printed tags.

It is further object of the present invention to provide a system and related method for creating a user-defined access to the data created by the user and stored in the virtual space.

It is yet further object of the present invention to provide a system and related method for dynamically linking tags with a virtual mini-repository of a registered user.

The invention features a system for dynamically linking tags with a virtual repository of a registered user, the system comprises a client mobile device having a scanner; at least one tag, the tag is encoded with a unique identification number; a server comprising a tag database, a user profile database, and a virtual space database; and a mobile application; wherein the mobile application is configured to send and receive data from the server, to read data encoded on the tags, and to enable a user to access, create, select, publish, and manage a static or interactive content on the virtual space database, and wherein the server is configured to send data to the mobile application, to receive and store data sent by the mobile application, and to link the tag identification number with a virtual space of the user.

In one instance, a tag is a barcode tag encoded using QR code, Aztec code, Data Matrix code, EZ code, High Capacity Color code, Maxi code, PDF417 code, or SPARQ code.

In another instance a tag is a radio frequency identification (RFID) tag or near field communication (NFC) tag.

According to some variants of present invention, the mobile device is a cellular telephone, a personal computer, a tablet, a laptop, or a personal digital assistant (PDA).

In one aspect, the data is metadata, multimedia data, interactive content data, user-defined virtual space access data, or security data, or combination thereof.

In another aspect, the data is the interactive content data for conducting commercial transactions.

In some embodiments of the present invention, the at least one tag is a printed tag or a virtual tag.

In some embodiments, the mobile application is configured to enable the user to create a customizable access to a virtual space database.

In some instances, the server is further configured to invalidate the link created between the tag identification number and the virtual space of the user if a predetermined condition is not met.

A method of dynamically linking tags with a virtual repository of a registered user using the system of the present invention described above is also disclosed. The method comprises the steps of: encoding at least one tag with a unique identification number; scanning the at least one tag using a mobile device of a user; reading the at lest one tags identification number by a mobile application uploaded to the mobile device and sending the at least one tag identification number to a server; storing the at least one tag identification number in a tag database maintained by the server; performing tag and user verification by the server; creating a virtual space of the user on a virtual space database maintained by the server; linking the at least one tags identification number to the virtual space of the user; generating data/user content using the mobile application; sending the data by the mobile application to the server; and storing the data in the virtual space of the user by the server.

According to one method of the present invention, the at least one tag is a barcode tag encoded using QR code, Aztec code, Data Matrix code, EZ code, High Capacity Color code, Maxi code, PDF417 code, or SPARQ code.

In one instance, the tag is an RFID tag or near field communication (NFC) tag.

In another instance, the mobile device is a cellular telephone, a personal computer, a tablet, a laptop, or a personal digital assistant (PDA).

According to one variant, the data is metadata, multimedia data, interactive content data, user-defined virtual space access data, or security data, or combination thereof.

In one aspect, the data is the interactive content data for conducting commercial transactions.

In another aspect, the at least one tag is a printed tag or a virtual tag.

In some instances, the method further comprises the step of obtaining an access to the virtual space of the user by scanning the tag linked to a virtual space of the user.

In some instances, the method further comprises the step of creating a user-defined permission to access specific data located in the virtual space of the user.

In some variants, the method further comprises the step of attaching the tag to an object.

And yet according to another variant, the method further comprises the step of invalidating the link created between the tag ID and the virtual space of the user if a predetermined condition is not met.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### DESCRIPTION OF DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is an illustration of a system for dynamically linking tags with a virtual repository of a registered user in accordance with one preferred embodiment of the present invention.

FIG. 2 is an illustration of a mobile application on a mobile device of a user in accordance with one of the embodiments of the present invention.

FIG. 3 is a diagram illustrating a process of dynamically linking tags with a virtual repository of a registered user using the system shown in FIG. 1 in accordance with the present invention.

FIGS. 4A and 4B is a detailed flow chart diagram illustrating a process of using the system of the present invention.

### DETAILED DESCRIPTION

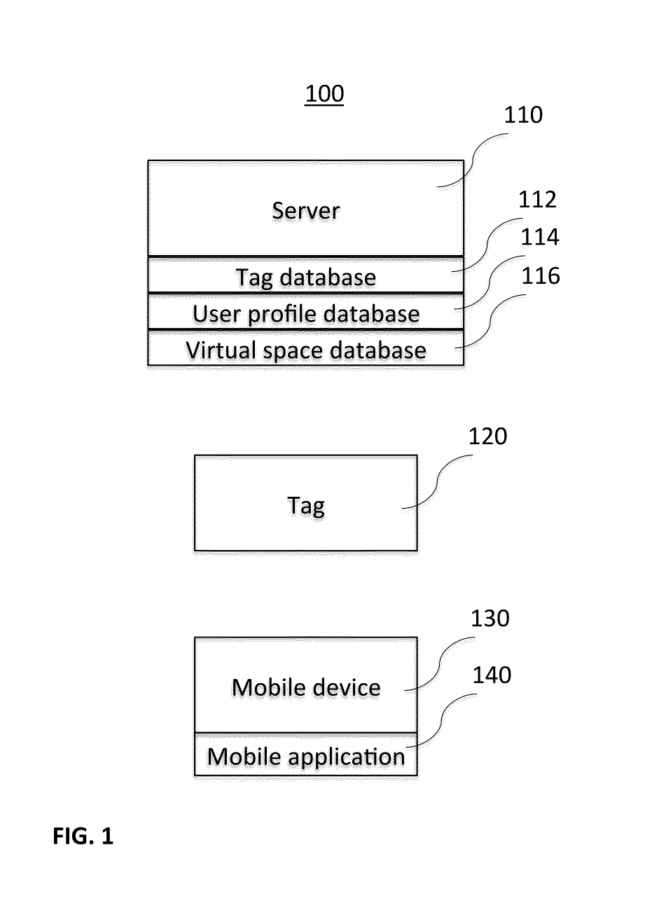

FIG. 1 illustrates a system (100) for dynamically linking tags with a virtual repository of a registered user in accordance with one embodiment of the present invention. The system comprises a client mobile device (130) having a scanner, a tag (120) encoded with a unique identification number, a server (110) comprising a tag database (112), a user profile database (114) and a virtual space database (116), and a mobile application (130) installed on the client mobile device (130).

The mobile application is configured to send to and receive data from the server, to read data encoded on the tags, and to enable a user to access, create, select, publish, and manage a static or interactive content on the virtual space database.

The server is configured to send data to the mobile application, to receive and store data sent by the mobile application, and to link the tag identification number with a virtual space of the user located in the virtual space database of the server.

According to the present invention, the tag can be a barcode tag encoded using quick response code (QR code), Aztec code, Data Matrix code, EZ code, High Capacity Color code, Maxi code, PDF417 code, and SPARQ code. In some embodiments of the present invention, the tag can be a radio frequency identification (RFID) tag or near field communication (NFC) tag. The mobile device of a user can be a cellular telephone, a personal computer, a tablet, a laptop, a personal digital assistant (PDA), or any other suitable mobile device.

The data that is sent by the server and the mobile application can be metadata, multimedia data, interactive content data, user-defined virtual space access data, security data, or combination thereof, or any other suitable type of data. The data can be the interactive content data for conducting commercial transactions, such as processing payments, or ordering consumer items, or any other commercial transactions including financial transactions.

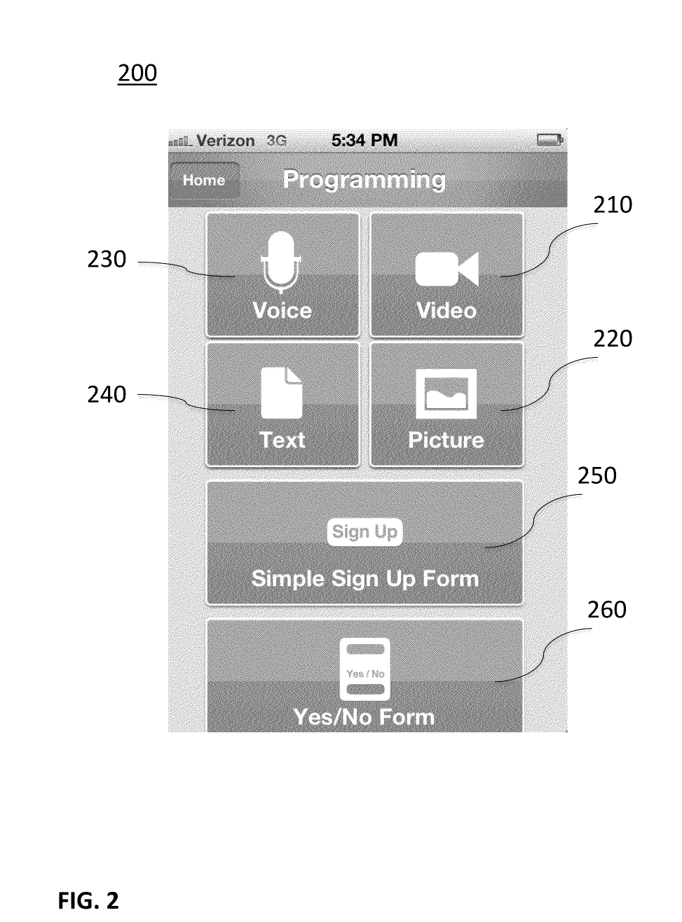

As shown in FIG. 2, the mobile application (200) enables the user to create content comprising multimedia data such as voice recording (230), video (210), picture (220), or text (240), or interactive data such as simple sign up form (250), or yes/no form (260). The tag can be a printed tag (i.e., printed on paper or any other material, or a virtual tag, i.e., computer-generated tag displayed on a screen of a mobile device).

In some preferred embodiments of the present invention, the mobile application is configured to enable the user to create a customizable (i.e., user-defined) access to the virtual space database. For example, the user can grant a general access to the virtual space by permitting any user to access any data located in the virtual space of the user. Alternatively, the user may specify that the user or users can access only certain specific data stored in the virtual space of the user (e.g., grants permission to access only media files, or only interactive data such as fillable forms, or only data associated with conducting commercial transactions).

The user can specify that the access to the user's virtual space is granted to any person, or to a particular person (by specifying the person's email address, for example).

A registered user is a user who went through the initial registration process and possesses a certain set of valid credentials to access the system (e.g., a user name and user password).

In some embodiments of the present invention, the server is further configured to invalidate the link created between the tag identification number and the virtual space of the user if a predetermined condition is not met. For example, when user A and user B would like to conduct a commercial transaction, such as monetary transfer, utilizing its smartphone, user A generates a virtual perishable tag, which presented to user B for visual inspection and for scanning User B scans the code and is presented with some kind of confirmation action such as an approval of transaction. User B accepts or declines the suggested action. If user B doesn't follow the suggested action in a certain timeframe, then the link that has been established between the identification number of the tag and the virtual space of the user A becomes invalidated (i.e., gets expired).

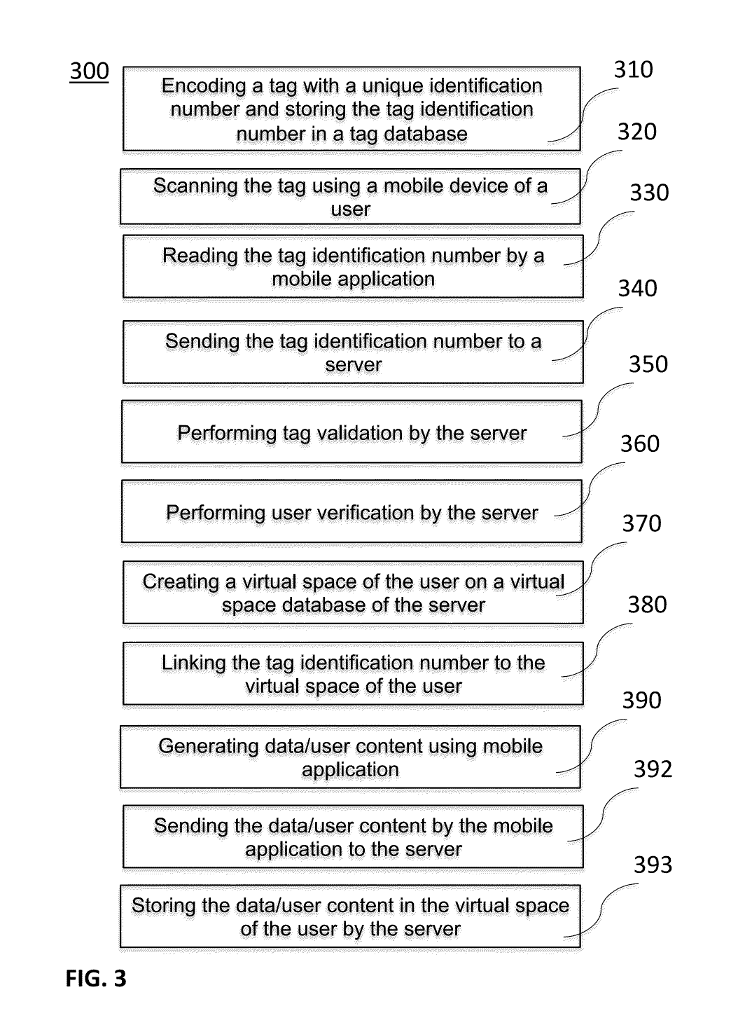

FIG. 3 illustrates a method (300) of dynamically linking tags with a virtual repository of a registered user using the system of the present invention. The method includes the steps of encoding a tag with a unique identification number and storing the tag identification number in a tag database (310), scanning the tag using a mobile device of a user (320), reading the tag identification number by a mobile application (330), sending the tag identification number to a server (340), performing tag validation (350) and user verification by the server (360), creating a virtual space of the user on a virtual space database of the server (370), linking the tag identification number to the virtual space of the user (380), generating data/user content using the mobile application (390), sending the data/user content by the mobile application to the server (392), and storing the data/user content in the virtual space of the user by the server (393). The sequence of steps can vary. For example, in some variants of the present invention, the step of creating a virtual space of the user on a virtual space database of the server (370) is conducted at the beginning of a sequence, prior to step (310).

According to the present invention, the tag can be a barcode tag encoded using quick response code (QR code), Aztec code, Data Matrix code, EZ code, High Capacity Color code, Maxi code, PDF417 code, or SPARQ code. In some embodiments of the present invention, the tag can be a radio frequency identification (RFID) tag or near field communication (NFC) tag. The mobile device of a user can be a cellular telephone, a personal computer, a tablet, a laptop, a personal digital assistant (PDA), or any other suitable mobile device.

The data that is sent by the server and the mobile application can be metadata, multimedia data, interactive content data, user-defined virtual space access data, security data, or combination thereof, or any other suitable type of data. The data can be the interactive content data for conducting commercial transactions, such as processing payments, or ordering consumer items, or any other commercial transactions including financial transactions. As shown in FIG. 2, the mobile application (200) enables the user to create content comprising multimedia data such as voice recording (230), video (210), picture (220), or text (240), or interactive data such as simple sign up form (250), or yes/no form (260). The tag can be a printed tag (i.e., printed on paper or any other material, or a virtual tag, i.e., computer-generated tag displayed on a screen of a mobile device).

In some preferred embodiments of the present invention, the mobile application is configured to enable the user to create a customizable (i.e., user-defined) access to the virtual space database. For example, the user can grant a general access to the virtual space by permitting any user to access any data located in the virtual space of the user. Alternatively, the user may specify that the user or users can access only certain specific data stored in the virtual space of the user (e.g., grants permission to access only media files, or only interactive data such as fillable forms, or only data associated with conducting commercial transactions). The user can specify that the access to the user's virtual space is granted to any person, or to a particular person (by specifying the person's last name, for example).

In some embodiments of the present invention, the server is further configured to invalidate the link created between the tag identification number and the virtual space of the user if a predetermined condition is not met. For example, when user A and user B would like to conduct a commercial transaction, such as monetary transfer, utilizing its smartphone, user A generates a virtual perishable tag, which presented to user B for visual inspection and for scanning User B scans the code and is presented with some kind of confirmation action such as an approval of transaction. User B accepts or declines the suggested action. If user B doesn't follow the suggested action in a certain timeframe, then the link that has been established between the identification number of the tag and the virtual space of the user A becomes invalidated (i.e., gets expired).

According to the present invention, the tag can be attached to an object, for example to a paper, or cardboard box, or to a consumer goods using an adhesive, or it can be printed on paper or other materials (wood, plastic, leather, or food products such as chocolate, and the like). Each tag can be linked to one virtual space of the user (so-called mini-repository) or to many virtual spaces of the user. A virtual space of the user can be created in real-time during the tag linking operation, or before the linking step, or the tag can be linked to a previously created virtual space (mini-repository) of a user. According to some methods of the present invention, each virtual space has a primary owner who is a registered user, and each user can have one or many mini-repositories that he/she owns. Once the tag is linked with the virtual space of a user, data manipulation and linkages are conducted with the virtual repository of the user. The tag does not need to carry information about the content created by the user and stored in the repository.

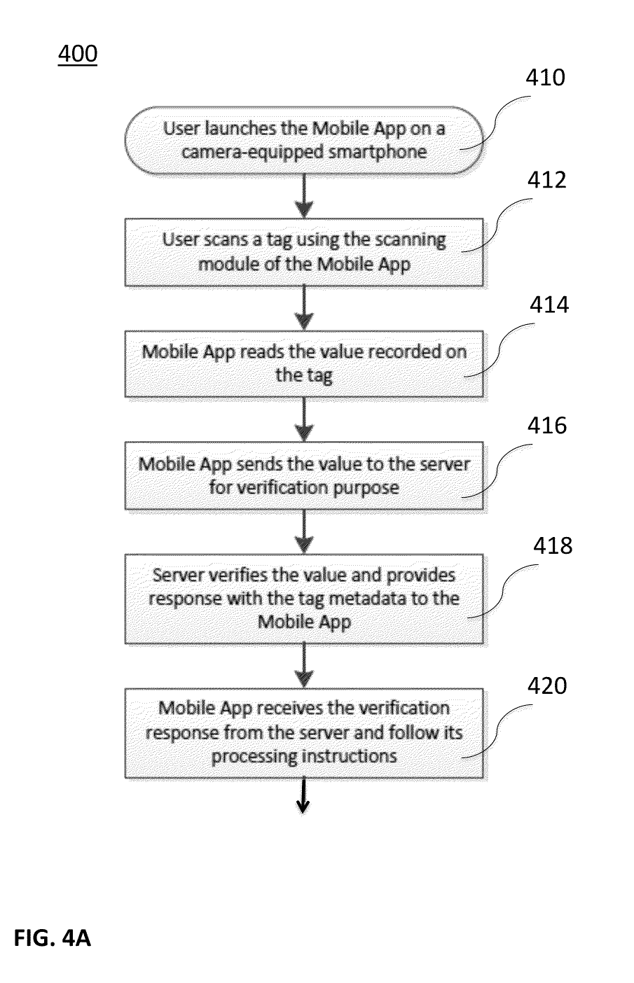

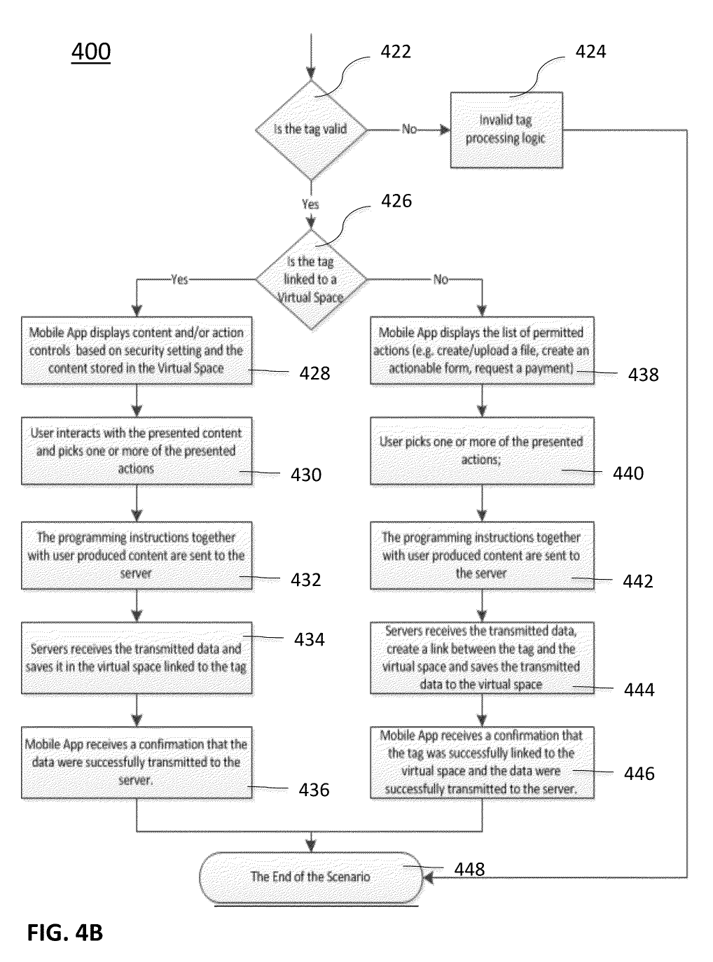

FIG. 4A (steps 410-420) and FIG. 4B (steps 422-448) illustrate in more detail a process (400) of dynamically linking tags with a virtual repository of a registered user using the system in accordance with the present invention. A user lunches a mobile application on a camera-equipped smartphone (410) and scans a tag using the scanning module of the mobile application (412). The mobile application read the value recorded on the tag, i.e., a unique tag identification number (414) and sends the value to the server for verification purposes (416). The server verifies the value and provides response with the tag metadata to the mobile application (418), and the mobile application receives the verification response from the server and follows its processing instructions (420). The process goes through the alternative set of steps if the tag is not valid (424). If the tag is valid and is linked to a virtual space of the user, then the mobile application displays content and/or action controls based on security setting and the content stored in the virtual space (428). The user interacts with the presented content and picks one or more of the presented allowable actions (430). The programming instructions together with the user-created content are sent to the server (432). The server receives the transmitted data and saves it in the virtual space of the user linked to the tag (434). The mobile application receives a confirmation that the data have been successfully transmitted to the server (436). If the tag has not been linked to a virtual space of the user, then the mobile application displays the list of permitted actions such as create/upload a file create an actionable form, request a payment (438). The user chooses one or more of the presented actions (440) and the programming instructions together with the user-created content are sent to the server (442). The server receives the transmitted data, creates a link between the tag and the virtual space and saves the transmitted data to the virtual space (444). The mobile application receives a confirmation that the tag was successfully linked to the virtual space and the data were successfully transmitted to the server (446).

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A system for dynamically linking tags with a virtual repository of a registered user, said system comprising:
a client mobile device having a scanner;
at least one tag, said at least one tag is encoded with a unique identification number;
a server comprising a tag database, a user profile database, and a virtual space database;
and a mobile application;
wherein the mobile application is configured to send to and receive data from the server, to read data encoded on the tags, and to enable a user to access, create, select, publish, and manage a static or interactive content on the virtual space database, and wherein the server is configured to send data to the mobile application, to receive and store data sent by the mobile application, and to link the tag identification number with a virtual space of the user.

2. The system of claim 1, wherein said at least one tag is a barcode tag encoded using the code selected from the group consisting of QR code, Aztec code, Data Matrix code, EZ code, High Capacity Color code, Maxi code, PDF417 code, and SPARQ code.

3. The system of claim 1, wherein said at least one tag is a radio frequency identification (RFID) tag or near field communication (NFC) tag.

4. The system of claim 1, wherein said mobile device is a cellular telephone, a personal computer, a tablet, a laptop, or a personal digital assistant (PDA).

5. The system of claim 1, wherein the data is metadata, multimedia data, interactive content data, user-defined virtual space access data, or security data, or combination thereof.

6. The system of claim 1, wherein the data is the interactive content data for conducting commercial transactions.

7. The system of claim 1, wherein said at least one tag is a printed tag or a virtual tag.

8. The system of claim 1, wherein the mobile application is configured to enable the user to create a customizable access to a virtual space database.

9. The system of claim 7, wherein the server is further configured to invalidate the link created between the tag identification number and the virtual space of the user if a predetermined condition is not met.

10. A method of dynamically linking tags with a virtual repository of a registered user using the system of claim 1, comprising the steps of:
encoding at least one tag with a unique identification number;
scanning the at least one tag using a mobile device of a user;
reading the tag identification number by a mobile application uploaded to the mobile device and sending the tag identification number to a server;
storing the tag identification number in a tag database maintained by the server;
performing tag and user verification by the server;
creating a virtual space of the user on a virtual space database maintained by the server;
linking the at least one tag identification number to the virtual space of the user;
generating data using the mobile application;
sending the data by the mobile application to the server;
and storing the data in the virtual space of the user by the server.

11. The method of claim 10, wherein said at least one tag is a barcode tag encoded using the code selected from the group consisting of QR code, Aztec code, Data Matrix code, EZ code, High Capacity Color code, Maxi code, PDF417 code, and SPARQ code.

12. The method of claim 10, wherein said tag is an RFID tag or near field communication (NFC) tag.

13. The method of claim 10, wherein said mobile device is a cellular telephone, a personal computer, a tablet, a laptop, or a personal digital assistant (PDA).

14. The method of claim 10, wherein the data is metadata, multimedia data, interactive content data, user-defined virtual space access data, or security data, or combination thereof.

15. The method of claim 10, wherein the data is the interactive content data for conducting commercial transactions.

16. The method of claim 10, wherein the at least one tag is a printed tag or a virtual tag.

17. The method of claim 10 further comprising the step of obtaining an access to the virtual space of the user by scanning the tag linked to a virtual space of the user.

18. The method of claim 10, further comprising creating a user-defined permission to access specific data located in the virtual space of the user.

19. The method of claim 10 further comprising the step of attaching the tag to an object.

20. The method of claim 10 further comprising the step of invalidating the link created between the tag identification and the virtual space of the user if a predetermined condition is not met.
